(19) United States
(12) Patent Application Publication
(10) Pub. No.: US 2020/0161677 A1
(43) Pub. Date: May 21, 2020

(54) FUEL CELL SYSTEM

(71) Applicant: TOYOTA JIDOSHA KABUSHIKI KAISHA, Aichi-ken (JP)

(72) Inventors: Ryo YOSHIOKA, Toyota-shi (JP); Nobuhiro TSUNEISHI, Toyota-shi (JP); Yuhei SUZUKI, Nagoya-shi (JP)

(21) Appl. No.: 16/689,084

(22) Filed: Nov. 20, 2019

(30) Foreign Application Priority Data
Nov. 21, 2018 (JP) 2018-218195

(51) Int. Cl. H01M 8/04007; H01M 8/04029

(52) U.S. Cl. CPC H01M 8/04074; H01M 2250/20; H01M 8/04029

(57) ABSTRACT

To provide a fuel cell system to be mounted in a space below the hood of a vehicle. The fuel cell system includes an FC assembly including an FC stack and a controller for controlling the FC stack; a cooling mechanism for cooling the FC stack, using a completely sealed cooling channel; and a reserve tank provided on a way of the cooling channel, the reserve tank being for storing coolant, wherein the reserve tank is disposed horizontally adjacent to the FC assembly.

### CROSS REFERENCE TO RELATED APPLICATION

This application claims priority to Japanese Patent Application No. 2018-218195 filed on Nov. 21, 2018, which is incorporated herein by reference in its entirety including the specification, claims, drawings, and abstract.

### TECHNICAL FIELD

This specification discloses a fuel cell system that is mounted in a space below the hood of a vehicle.

### BACKGROUND

Conventionally, vehicles with fuel cells have been proposed. As such a fuel cell generates heat in power generation, the fuel cell needs to be cooled with coolant when necessary. Hence, a typical fuel cell system includes, for example, a coolant channel for coolant to flow therein, a radiator for thermal exchange between the coolant and fresh air, and a reserve tank for storing the coolant.

Patent Document 1 discloses a fuel cell system that incorporates a cooling mechanism. In Patent Document 1, a reserved tank is disposed above a fuel cell stack in consideration of hydraulic head.

### CITATION LIST

### Patent Literature

PATENT DOCUMENT 1: JP 2012-18761 A

In recent years, disposition of a fuel cell system in a space below the hood; that is, in a power unit chamber (corresponding to the engine room of an engine vehicle), has been proposed. A typical hood is relatively soft so that, if the vehicle hits a passenger and the passenger bounces over the hood, the hood will deform to protect the passenger. For this purpose, an ample space should be left between the hood and the fuel cell system to accommodate deformation of the hood.

Meanwhile, in the case where a reserve tank is disposed above the fuel cell stack, as is in Patent Document 1, the fuel cell system resultantly becomes taller as a whole by an amount corresponding to the height of the reserve tank. This insists on disposition of the hood at a higher position. Consequently, the degree of freedom in designing the front portion, including the hood, of a vehicle decreases.

In view of the above, this specification discloses a fuel cell system to be disposed in a space below the hood of a vehicle without decreasing the degree of freedom in designing the front portion of the vehicle.

### SUMMARY

A fuel cell system disclosed in this specification is a fuel cell system to be mounted in a space below the hood of a vehicle, the fuel cell system including: an FC assembly including a fuel cell stack and a controller for controlling the fuel cell stack; a cooling mechanism for cooling the fuel cell stack, using a completely sealed cooling channel; and a reserve tank disposed on a way of the cooling channel, the reserve tank being for storing coolant, wherein the reserve tank is disposed horizontally adjacent to the FC assembly.

With this structure, it is possible to keep the height of a fuel cell system lower. This disposition can prevent decrease in the degree of freedom in disposition of the hood in terms of height and thus decrease in the degree of freedom in designing the front portion of a vehicle.

In this case, the reserve tank may be disposed forward adjacent to the FC assembly, and the upper end of the reserve tank may be positioned lower, in height, than the upper end of the front end surface of the FC assembly.

With this structure, it is possible to exclude a reserve tank from factors that govern the height of the fuel cell system, and thus factors that govern the height of the hood in disposing the hood. This can increase the degree of freedom in disposition of the hood in terms of height.

The reserve tank may be securely mounted on the circumferential surface of the FC assembly via a support bracket.

With this structure, the reserve tank functions as a mass damper that prevents resonance of the FC assembly. This can reduce vibration and thus noise.

In this case, the reserve tank may include a valve joint that is linked to an electric valve via a pipe, and the support bracket may be mounted on the reserve tank at a position closer to the valve joint than to the center of the reserve tank in the width direction.

With this structure, the support bracket is mounted at a position near the valve joint to which vibration is likely to be transmitted, so that vibration can be more effectively prevented.

The support bracket may connect the base surface of the reserve tank and the circumferential surface of the FC assembly.

With this structure, the weight of the reserve tank can be reliably supported by the FC assembly.

In this case, the support bracket may include a tank-side end portion mounted on the bottom surface of the reserve tank, a case-side end portion mounted on the circumferential surface of the FC assembly, and an intermediate portion connecting the tank-side end portion and the case-side end portion, and the intermediate portion has a shape that substantially linearly connects the tank-side end portion and the case-side end portion.

With this structure, the length of the intermediate portion can be reduced, and the material of the bracket can also be reduced.

In this case, the support bracket may be mounted on the reserve tank via a mounting rubber.

With this structure, vibration between the reserve tank and the FC assembly can be effectively absorbed.

According to the fuel cell system disclosed in this specification, it is possible to dispose the fuel cell system in a space below the hood of a vehicle without decreasing the degree of freedom in designing the front portion of the vehicle.

### BRIEF DESCRIPTION OF DRAWINGS

Embodiment(s) of the present disclosure will be described based on the following figures, wherein:

FIG. 1 is a schematic plan view of a fuel cell system;

FIG. 2 is a schematic side view of a fuel cell system;

FIG. 3 is a front view of a reserve tank and its vicinity;

FIG. 4 is an end surface view along the line A-A in FIG. 3; and

FIG. 5 is a block diagram illustrating the structure of a cooling mechanism.

### DESCRIPTION OF EMBODIMENTS

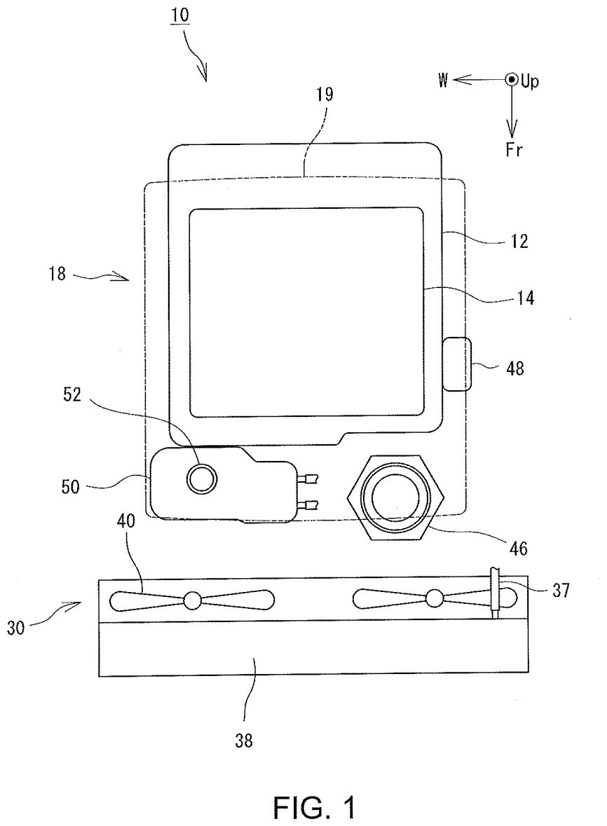

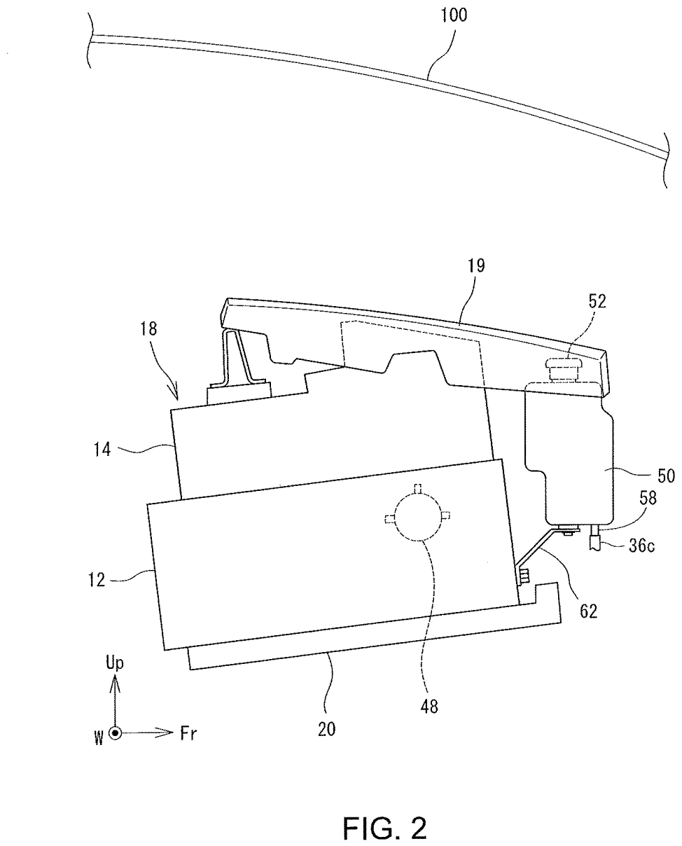

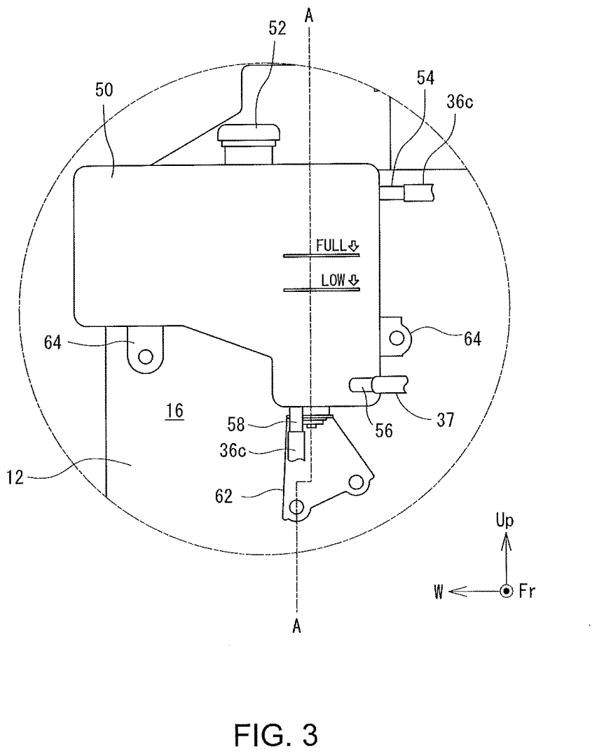

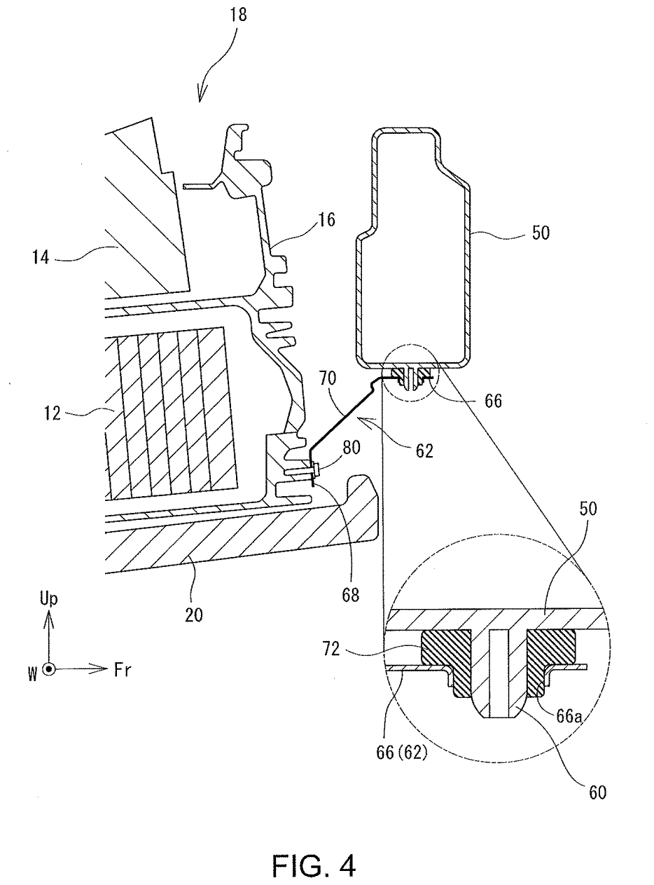

The structure of a fuel cell system 10 will now be described with reference to the following drawings. FIG. 1 is a schematic plan view of the fuel cell system 10. FIG. 2 is a side view of the fuel cell system 10. FIG. 3 is a front view of a reserve tank 50 and its vicinity. FIG. 4 is an end surface view along the line A-A in FIG. 3. The drawings illustrate only major parts, with pipes and pumps not illustrated. In FIG. 1, a design cover 19 is illustrated with a long dashed double-short dashed line, and members under the fuel cell system 10 are illustrated with a solid line. In FIG. 3 and FIG. 4, the design cover 19 is not illustrated. In the drawings, “Fr”, “W”, and “Up” indicate the forward, width, and upward directions of a vehicle, respectively.

The fuel cell system 10 is mounted on a vehicle, and can be used as a power source that supplies power to an electric motor for running, for example. In this embodiment, the fuel cell system 10 is mounted in a space below the hood; that is, in a power control chamber. Thus, as illustrated in FIG. 2, a hood 100 is disposed at a slant above the fuel cell system 10 so as to ascend rearward. The hood 100 is relatively soft and readily deformable in order to deform if the vehicle hits a passenger and the passenger bounces over the hood 100, to thereby reduce a load to be applied to the passenger.

As illustrated in FIG. 1 to FIG. 4, the fuel cell system 10 includes an FC assembly 18 and a cooling mechanism 30. The FC assembly 18 includes a fuel cell stack (hereinafter referred to as an “FC stack”) and a controller 14. The cooling mechanism 30 cools the FC stack 12.

The FC stack 12 includes a plurality of cells of a fuel cell that generates power through electrochemical reaction between hydrogen and oxygen. The plurality of cells are stacked in the front-back direction of the vehicle, and held between a pair of end plates. As a fuel cell, a solid high polymer fuel cell is usable, although the type of the fuel cell is not limited to a solid high polymer fuel cell, and, for example, phosphoric acid type fuel cells or molten carbonate fuel cells are usable.

The FC stack 12 is held in a stack case 16 (refer to FIG. 4), and fixed to the vehicle via a base member 20. In fixing, the FC stack 12 is securely placed at a slant so as to descend rearward so that liquid in the FC stack 12 flows efficiently. That is, the FC stack 12 includes a cooling channel 32 and a gas channel, in which coolant flows in the cooling channel 32, and fuel gas and oxidizing gas flow in the gas channel. In this embodiment, the FC stack 12 is disposed at a slant so as to descend rearward so that the coolant and water flow smoothly in the cooling channel 32 and the gas channel, to be discharged to the outside of the FC stack 12. Note that the water flowing in the gas channel is water having been supplied to humidify the fuel gas or oxidizing gas, or water having been generated in power generation.

The FC stack 12 has the controller 14 disposed thereabove. The controller 14 controls power and current generated by the FC stack 12. In this embodiment, as illustrated in the drawings, the stack case 16 has a two-story structure so that the FC stack 12 is disposed on the lower side and the controller 14 is disposed on the upper side. The FC stack 12 and the controller 14 are put together in the stack case 16 for unitization, thereby constituting the FC assembly 18.

The cooling mechanism 30 supplies coolant to the FC stack 12 to cool the FC stack 12. In this embodiment, a so-called completely sealed cooling mechanism 30 is employed in which the coolant is not in contact with fresh air. As the coolant, for example, a mixed solution of ethyleneglycol and water; that is, antifreeze, is usable to prevent freezing at lower temperature.

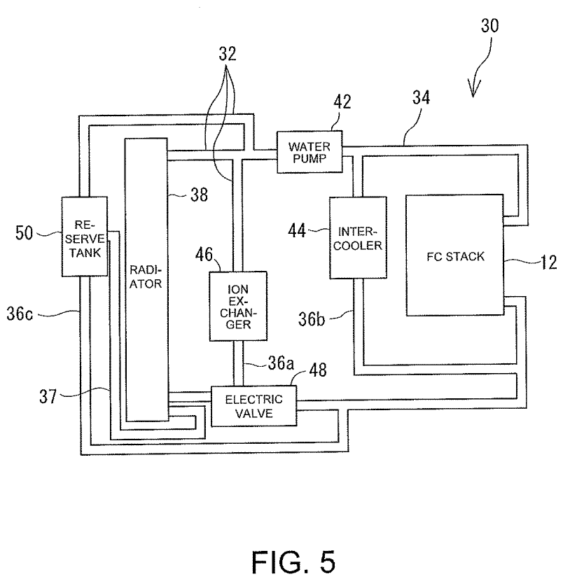

FIG. 5 is a block diagram illustrating the structure of the cooling mechanism 30. As illustrated in FIG. 5, the cooling mechanism 30 includes the cooling channel 32 in which coolant flows. The cooling channel 32 has, for example, a radiator 38 and a water pump 42 disposed on its way. The cooling channel 32 includes a main channel 34, bypass channels 36a to 36c, and a communicating channel 37. Specifically, the coolant from the FC stack 12 flows in the main channel 34 through the radiator 38 to return to the FC stack 12. The bypass channels 36a to 36c are branched from the main channel 34. The radiator 38 communicates with the reserve tank 50 through the communicating channel 37.

The radiator 38 is a heat exchanger that cools the coolant discharged from the FC stack 12, through heat exchange with fresh air. Behind the radiator 38, a radiator fan 40 is disposed to accelerate heat exchange. The water pump 42 is disposed on the way of the main channel 34 to feed the coolant with pressure. One bypass channel; namely, the bypass channel 36a, for example, has an ion exchanger 46 that absorbs ions from the coolant for removal thereof. Another bypass channel; namely, the bypass channel 36b, for example, has an intercooler 44 for heat exchange between coolant and air supplied to the FC stack 12.

An electric valve 48 is disposed at a point where the main channel 34 joins the bypass channel 36a to adjust the flow ratio between the coolant passing through the radiator 38 and the coolant passing through the bypass channels 36a. As illustrated in FIG. 1 and FIG. 2, the electric valve 48 is disposed on a side surface (on the right side surface as the viewer faces the front of the stack case 16 in the example illustrated) of the stack case 16.

A still other bypass channel; namely, the bypass channel 36c, for example, has the reserve tank 50 for storing the coolant. The reserve tank 50 communicates with the radiator 38 through the communicating channel 37 to supply and receive coolant with respect to the radiator 38. The reserve tank 50 is a so-called completely sealed reserve tank 50, which is not exposed to air but is completely closed. The air staying in the upper portion of the reserve tank 50 functions as a damper, so that the pressure variation of the coolant due to variation in temperature can be absorbed.

As illustrated in FIG. 2 and FIG. 3, the reserve tank 50 has a cap 52 on the top thereof. The cap 52 has a function as a pressure adjusting valve. The cap 52 is made of resin, for example, and is removably attached to the reserve tank 50 through screwing, for example. The cap 52 functions so as to discharge vapor inside the tank when the pressure inside the tank becomes higher, and to introduce fresh air into the inside of the tank when the pressure inside the tank becomes lower, to thereby keep the pressure inside the tank normal.

As illustrated in FIG. 1 and FIG. 2, the design cover 19 is disposed above the FC assembly 18, covering the upper surface of the FC assembly 18 and the cap 52 of the reserve tank 50 from above. With the design cover 19 so disposed, a user can be prevented from unnecessarily touching the electric components in the upper portion (that is, the upper portion of the controller 14) of the FC assembly 18 and the cap 52 of the reserve tank 50.

As is obvious from FIG. 1 and FIG. 2, in this embodiment, the reserve tank 50 is disposed forward adjacent to the FC assembly 18. In other words, the reserve tank 50 is disposed horizontally adjacent to the FC stack 12. This structure is employed for the reason below.

Conventionally, the reserve tank 50 is often disposed above the FC assembly 18. In particular, when a simply sealed cooling mechanism 30, in which the reserve tank 50 is open to air, is used, the reserve tank 50 is positioned further upward than the FC stack 12, as is necessary in view of hydraulic head. Such disposition of the reserve tank 50 above the FC assembly 18 leads to an increase in height of the entire fuel cell system 10.

Further, the fuel cell system 10 is disposed below the hood 100, as described earlier, and an ample space is necessary between the hood 100 and the fuel cell system 10 for protection of passengers. Disposition of the reserve tank 50 above the FC assembly 18 and resultant increase in height of the fuel cell system 10 lead to disposition of the hood 100 at a higher position, which raises a problem in that the degree of freedom in designing the front portion of a vehicle decreases. One possibility is devising the shape of the reserve tank 50 such that increase in height of the fuel cell system 10 can be prevented. This devising, however, may raise other problems, including restriction on the capacity of the reserve tank 50.

To address the above, in this embodiment, the reserve tank 50 is disposed horizontally adjacent to the FC assembly 18, as described above. This disposition makes it possible to dispose the reserve tank 50 such that its upper end does not exceed the upper end of the FC assembly 18, without excessive restriction of the capacity (the size) of the reserve tank 50. Consequently, the reserve tank 50 is excluded from the factors that govern the height of the fuel cell system 10; that is, factors that govern the height in disposing the hood 100. This can enhance the degree of freedom in disposing the hood 100 in terms of height.

As described above, the simply sealed cooling mechanism 30 requires disposal of the reserve tank 50 above the FC stack 12 because of hydraulic head. In contrast, this embodiment, employing a completely sealed cooling mechanism 30, allows disposition of the reserve tank 50 at a position substantially as high as the FC stack 12 without need of considering hydraulic head.

The structure and disposition of the reserve tank 50 will now be described. The reserve tank 50 has the cap 52 on the top thereof, as described above. As is obvious from FIG. 3, the reserve tank 50 includes three joints 54, 56, 58 to which pipes constituting the cooling channels 32 are connected. The first to third joints 54, 56, 58 are tubular members that communicate with the inside space of the reserve tank 50.

The first joint 54 is positioned near the upper end of the reserve tank 50 on the right side as the viewer faces the front of the reserve tank 50 and functions as a valve joint to which a pipe (the bypass channel 36c) connecting the reserve tank 50 and the electric valve 48 (more correctly, the main channel 34 near the electric valve 48) is connected. The second joint 56 is positioned near the lower end of the reserve tank 50 on the right side as the viewer faces the front of the reserve tank 50 and is connected to a pipe (the communicating channel 37) connecting the reserve tank 50 and the radiator 38. The third joint 58 extends downward from the bottom surface of the reserve tank 50 to be connected to a pipe (the bypass channel 36c) connecting the reserve tank 50 and the main channel 34.

The reserve tank 50 is fixed to the front end surface of the stack case 16 via a support bracket 62 and a sub-bracket 64. The sub-bracket 64 connects the reserve tank 50 and the front end surface of the stack case 16. Two sub-brackets 64 are provided on each of the right and left sides. Each sub-bracket 64 is fastened to the stack case 16 via a bolt.

The support bracket 62 connects the base surface of the reserve tank 50 and the front end surface of the stack case 16. As illustrated in FIG. 4, a mounting rib 60 is formed on the bottom surface of the reserve tank 50 so as to extend therefrom. The support bracket 62 is to be mounted on the mounting rib 60. The mounting rib 60 is a tubular rib having a tapered shape projecting downward. The tapered shape facilitates attachment of a mounting rubber 72, to be described later.

As illustrated in FIG. 2 and FIG. 4, the support bracket 62 includes a tank-side end portion 66, a case-side end portion 68, and an intermediate portion 70. The tank-side end portion 66 is mounted on the bottom surface of the reserve tank 50. The case-side end portion 68 is mounted on the front end surface of the stack case 16. The intermediate portion 70 connects the tank-side end portion 66 and the case-side end portion 68.

The tank-side end portion 66 has an insertion hole 66a into which the mounting rubber 72 can be inserted. Meanwhile, the case-side end portion 68 has two fastening holes, into each of which a fastening bolt 80 can be inserted. The fastening bolt 80 is screwed on the front end surface of the stack case 16.

The support bracket 62 is mounted on the bottom surface of the reserve tank 50 via the mounting rubber 72. The mounting rubber 72 is made of elastic member that can absorb vibration, and has a stepped shape including an upper portion and a lower portion. The outside diameter of the upper portion of the mounting rubber 72 is larger than that of the lower portion. The mounting rubber 72 has a substantially tubular shape having a through hole penetrating at the middle portion thereof. The outside diameter of the upper portion of the mounting rubber 72 is sufficiently larger than the inner diameter of the insertion hole 66a, and the outside diameter of the lower portion is substantially equal to or slightly smaller than the inner diameter of the insertion hole 66a.

In mounting the support bracket 62 on the reserve tank 50, the mounting rubber 72 is attached to the mounting rib 60, and the lower portion of the mounting rubber 72 is inserted into the insertion hole 66a. Consequently, the mounting rubber 72 intervenes between the support bracket 62 and the reserve tank 50, whereby transmission of vibration between the FC stack 12 and the reserve tank 50 can be prevented.

With the support bracket 62 mounted on the reserve tank 50 and the stack case 16, the case-side end portion 68 is positioned lower and further rearward than the tank-side end portion 66. Thus, the intermediate portion 70 extends so as to descend rearward while linearly connecting the case-side end portion 68 and the tank-side end portion 66. The linear shape (an inclined shape) of the intermediate portion 70 enables reduction in length of an area where the intermediate portion 70 is disposed, and thus reduction in the amount of material necessary to form the support bracket 62.

As is obvious from the above description, in this embodiment, the reserve tank 50 is mechanically connected to the FC assembly 18 via the support bracket 62. This structure makes it possible for the reserve tank 50 to function as a mass damper of the FC assembly 18 to prevent vibration of the FC assembly 18.

Here, various electronic components, such as the electric valve 48, are mounted on the FC assembly 18, and driving these electronic components causes vibration and thus noise. Such noise will be transmitted from the stack case 16 through the body to the vehicle cabin to deteriorate comfortability of an occupant. In particular, in the case of an electric motor vehicle equipped with a motor alone, with no engine, as a power source for supplying power to a vehicle to run, such noise attributed to vibration of the electronic components is significantly notable due to the lack of engine noise, and thus makes an unignorable problem.

The reserve tank 50 is a heavy load having coolant inside. Fixing such a reserve tank 50 on the circumferential surface of the FC assembly 18 via a bracket allows the reserve tank 50 to function as a mass damper, thus enabling prevention of resonance due to driving of the electric valve 48 or the like. Consequently, it is possible to reduce noise due to driving of these electronic components.

Note that, among the electronic components mounted on the FC assembly 18, the electric valve 48 in particular is highly likely to vibrate. In this embodiment, in order to enhance the damping effect by the reserve tank 50, the support bracket 62 is mounted on the reserve tank 50 at a position to which vibration from the electric valve 48 is likely to be transmitted.

Specifically, in this embodiment, the support bracket 62 is mounted at a position rightward as the viewer faces the front of the reserve tank 50 of the middle of the reserve tank 50 in the width direction; in other words, in a position close to the first joint 54. That is, vibration of the electric valve 48 is likely to be transmitted to the first joint 54, to which the pipe connecting the electric valve 48 and the reserve tank 50 is connected, and its vicinity. In this view, the support bracket 62 is mounted at a position relatively close to the first joint 54 in this embodiment, so that the damping effect by the reserve tank 50 can be enhanced.

Note that the above-described structure is merely an example, and that structures other than the structure in which the reserve tank 50 is disposed horizontally adjacent to the FC assembly 18 can be discretionally modified. For example, although in the above description the reserve tank 50 is disposed in front of the FC assembly 18, the reserve tank 50 can be disposed in any other positions, provided that the reserve tank 50 is disposed horizontally adjacent to the FC assembly 18. For example, the reserve tank 50 can be disposed on the right or left side of the FC assembly 18 or in front of or behind the FC assembly 18 in the front-back direction of the vehicle.

Although in the above description the reserve tank 50 is fixed to the FC assembly 18 via the support bracket 62 so that the reserve tank 50 can function as a mass damper, the reserve tank 50 can be fixed to any other member independent of the FC case, such as the base member 20, provided that the damping effect by the FC assembly 18 is ensured. In addition, the shapes and dimensions of the reserve tank 50 and the bracket can be discretionally modified.

### REFERENCE SIGNS LIST

10 fuel cell system, 12 FC stack, 14 controller, 16 stack case, 18 FC assembly, 19 design cover, 20 base member, 30 cooling mechanism, 32 cooling channel, 38 radiator, 40 radiator fan, 42 water pump, 44 intercooler, 46 ion exchanger, 48 electric valve, 50 reserve tank, 52 cap, 54 first joint, 56 second joint, 58 third joint, 60 mounting rib, 62 support bracket, 64 sub-bracket, 66 tank-side end portion, 68 case-side end portion, 70 intermediate portion, 72 mounting rubber, 80 fastening bolt, 100 hood.

1. A fuel cell system to be mounted in a space below a hood of a vehicle, the fuel cell system comprising:
an FC assembly including a fuel cell stack and a controller for controlling the fuel cell stack;
a cooling mechanism for cooling the fuel cell stack, using a completely sealed cooling channel; and
a reserve tank disposed on a way of the cooling channel, the reserve tank being for storing coolant,
wherein
the reserve tank is disposed horizontally adjacent to the FC assembly.

2. The fuel cell system according to claim 1, wherein
the reserve tank is disposed forward adjacent to the FC assembly, and
an upper end of the reserve tank is positioned lower, in height, than an upper end of a front end surface of the FC assembly.

3. The fuel cell system according to claim 1, wherein the reserve tank is securely mounted on a circumferential surface of the FC assembly via a support bracket.

4. The fuel cell system according to claim 3, wherein
the reserve tank includes a valve joint that is linked to an electric valve via a pipe, and
the support bracket is mounted on the reserve tank at a position closer to the valve joint than to a center of the reserve tank in a width direction.

5. The fuel cell system according to claim 3, wherein the support bracket connects a base surface of the reserve tank and the circumferential surface of the FC assembly.

6. The fuel cell system according to claim 5, wherein
the support bracket includes a tank-side end portion mounted on a bottom surface of the reserve tank, a case-side end portion mounted on the circumferential surface of the FC assembly, and an intermediate portion connecting the tank-side end portion and the case-side end portion, and
the intermediate portion has a shape that substantially linearly connects the tank-side end portion and the case-side end portion.

7. The fuel cell system according to claim 3, wherein the support bracket is mounted on the reserve tank via a mounting rubber.
